(19) United States
(12) Patent Application Publication
(10) Pub. No.: US 2021/0028626 A1
(43) Pub. Date: Jan. 28, 2021

(54) TWIN-FED ASYNCHRONOUS MACHINE HAVING FLYWHEEL AS PHASE SHIFTER AND ENERGY SOURCE

(71) Applicant: Siemens Aktiengesellschaft, Munich (DE)

(72) Inventors: Jens Rosendahl, Hamm (DE); Roland Sievert, Duisburg (DE); Klaus-Dieter Walli, Mühlheim an der Ruhr (DE)

(73) Assignee: Siemens Aktiengesellschaft, Munich (DE)

(21) Appl. No.: 17/041,608

(22) PCT Filed: Mar. 27, 2019
(86) PCT No.: PCT/EP2019/057788

§ 371 Date: Sep. 25, 2020

(30) Foreign Application Priority Data
Mar. 28, 2018 (DE) 10 2018 204 787.1

(51) Int. Cl. H02J 3/30; H02J 3/18; H02P 9/00

(52) U.S. Cl. CPC H02J 3/30; H02P 2103/10; H02P 9/007; H02J 3/1885

(57) ABSTRACT

A system that is directly coupled to the transmission network or the distribution network, wherein a variable-speed, twin-fed asynchronous machine is combined with a flywheel. Besides the function as a voltage-regulating phase shifter, energy in the flywheel can at the same time be stored or removed as the speed changes. The provided properties relate to a combination of frequency support, voltage stabilisation, energy storage and short-circuit capacity. In a particular embodiment the speed of the flywheel is increased in relation to the speed of the rotor by a transmission, wherein the capability of the flywheel to store energy advantageously rises disproportionally with the speed.

### CROSS REFERENCE TO RELATED APPLICATIONS

This application is the US National Stage of International Application No. PCT/EP2019/057788 filed 27 Mar. 2019, and claims the benefit thereof. The International Application claims the benefit of German Application No. DE 10 2018 204 787.1 filed 28 Mar. 2018. All of the applications are incorporated by reference herein in their entirety.

### FIELD OF INVENTION

The invention relates to a system that is able to be used to support a three-phase supply grid, but also as an energy store.

### BACKGROUND OF INVENTION

Highly volatile energy production requires grid support systems for voltage stability and frequency stability purposes. The output power from most renewable generators is subject to strong fluctuations. In the event of rapid changes in power, it is necessary to provide reserves in order to compensate reactive power and active power and also short-circuit power.

In order to support the voltage, use is made inter alia of synchronously rotating phase shifters that differ only slightly from conventional synchronous machines in fossil-fuel power plants in terms of structure. For frequency support purposes, it is necessary to use reserve generators or energy stores that however require a certain amount of time to achieve full performance or are limited in terms of their output.

In order to damp very rapid frequency changes, flywheels are also in some cases installed on synchronously rotating phase shifters, which flywheels increase the inertia with respect to these changes and give the reserve systems more time to reach the required power.

Said solutions have been known for a long time at the system level.

The invention is based on the problem of providing an energy store for a supply grid, in particular a three-phase supply grid, which is capable of buffer-storing an amount of energy that is significantly higher than that of a synchronously rotating phase shifter.

### SUMMARY OF INVENTION

The problem is solved by a system having the features of the independent claim.

One element that is essential to the invention is the ability to control the speed of the flywheel and thus the option to control a high amount of energy to be absorbed or to be output. This is the opposite from conventional phase shifter systems that are able to absorb or output only very small amounts of energy due to the speed, which is linked rigidly to the grid.

The present invention has a combination of a frequency-stabilizing and voltage-stabilizing function with a rotating energy store. This is achieved by way of a system that rotates at a speed able to be controlled variably and is coupled directly to the transmission or distribution grid.

The system according to the invention, in combination with flywheels as a veritable energy store, opens up a high power class.

Advantageous developments of the invention are specified in the dependent claims.

In one particular development of the invention, the rotor of the asynchronous machine is connected to the flywheel via a transmission that boosts the speed. This measure makes use of the finding that the ability of the flywheel to store energy increases in excess proportion to the speed.

### BRIEF DESCRIPTION OF THE DRAWINGS

The invention is explained in more detail below in the form of an exemplary embodiment, in a scope required for understanding, with reference to a figure, in which:

FIG. 1 shows a variable-speed doubly fed asynchronous machine in combination with a flywheel.

### DETAILED DESCRIPTION OF INVENTION

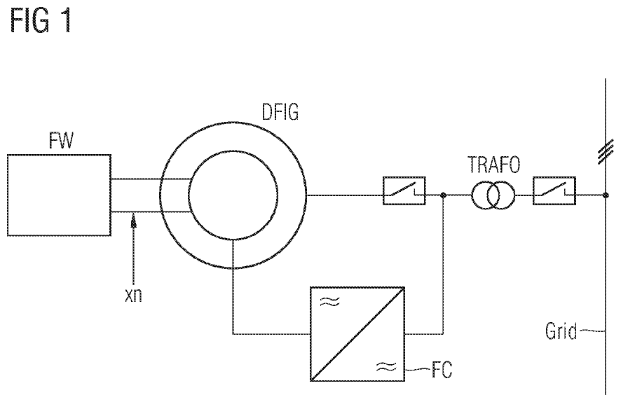

The system illustrated in FIG. 1 has an asynchronous machine DFIG that is connected to a three-phase grid GRID via a transformer TRAFO. The rotor of the asynchronous machine is electrically connected to the grid via a frequency converter FC and coupled mechanically to a flywheel FW. The stator of the asynchronous machine is electrically connected to the grid.

The variable-speed doubly fed asynchronous machine, in combination with a flywheel, offers a combination of the properties of frequency support, voltage stabilization, energy store and short-circuit power.

In contrast to the conventional synchronous machine, the rotor is fed with a variable-frequency three-phase current and is therefore able to control the speed of the rotor, and thus of the flywheel, when all of the requirements in terms of a synchronous phase shifter are met. In addition to the function as a voltage-regulating phase shifter, energy in the flywheel is at the same time able to be stored or drawn by changing the speed.

The amount of energy depends on the design of the flywheel (for example coupled directly or via a transmission xn that boosts the speed) and the speed range that is implemented. The transmission xn has a transmission ratio times n, wherein n is a natural number.

The power available in the short term corresponds to the power class of the phase shifter. It is possible to achieve very high power classes and power densities.

Power/time control of the charging or discharging of the mechanical energy store is possible for example using the following modes: measuring the grid frequency and automatically setting the power absorption or power output in accordance with the requirement profile of the grid operator for the services PCP (primary control power) or EFR (enhanced frequency response, Great Britain); measuring the grid frequency gradient and setting the power as a countermeasure for rapid frequency changes (active damping of the RoCoF: rate of change of frequency); controlling the speed gradient in order to control power absorption and output in a targeted manner, for example in order to store energy over day/night cycles or as a preventive measure for predictable stability bottlenecks. The voltage-regulating properties of a synchronous phase shifter are in this case also ensured.

In comparison with alternative variable-frequency solutions involving full inverter systems (such as for example turbogenerators having frequency converters at the output terminals, synchronous grid up to 380 MW), the system according to the invention advantageously has lower losses and considerably reduced expenditure.

In comparison with other technical solutions based on expensive large power electronics components, such as for example SVC Plus Supercapacitors and battery stores, the system according to the invention has considerably improved core grid stabilization properties.

The power balance of the system will be approximately zero (absorbed minus output energy), as a result of which the system form does not fit in with generator technology, but rather with energy stores on the one hand and grid support systems on the other hand.

The present invention has been explained in detail for illustrative purposes on the basis of specific exemplary embodiments. Elements of the individual exemplary embodiments may in this case also be combined with one another. The invention is therefore not intended to be restricted to individual exemplary embodiments, but rather only to be restricted by the appended claims.

1. A system for supporting a three-phase supply grid but also in the form of an energy store, comprising:
an asynchronous machine whose rotor interacts with a flywheel,
wherein the asynchronous machine is fed firstly from the three-phase supply grid and is fed secondly with a variable-frequency three-phase current.

2. The system as claimed in claim 1,
wherein the flywheel is connected directly to the rotor of the asynchronous machine.

3. The system as claimed in claim 1,
wherein the flywheel is connected to the rotor of the asynchronous machine via a transmission (xn).

4. The system as claimed in claim 3,
wherein the transmission has a transmission ratio that increases the speed of the flywheel with respect to the speed of the rotor.

5. The system as claimed in claim 3,
wherein the transmission is provided with a structure having an infinitely variable transmission ratio.

6. The system as claimed in claim 1,
wherein the rotor is fed with variable-frequency three-phase current.

7. The system as claimed in claim 6,
wherein the rotor is fed from the three-phase supply grid via a frequency converter.

8. The system as claimed in claim 1,
wherein the three-phase supply grid is provided by a distribution grid.

9. The system as claimed in claim 1,
wherein the three-phase supply grid is provided by a transmission grid.

10. The system as claimed in claim 1,
wherein power/time control of energy charging or energy discharging is provided.

11. The system as claimed in claim 1,
wherein a power absorption or a power output is controlled in accordance with a measured grid frequency.

12. The system as claimed in claim 1,
wherein a power absorption or a power output is controlled in accordance with a grid frequency gradient.

13. The system as claimed in claim 1,
wherein a power absorption or a power output is controlled in accordance with a speed gradient.
